(19) United States
(12) Patent Application Publication
(10) Pub. No.: US 2013/0152855 A1
(43) Pub. Date: Jun. 20, 2013

(54) Pneumatic repair mortar gun

(71) Applicants: Mark Allen Hartman, Inyokern, CA (US); Charles Fredric Hartman, Boron, CA (US)

(72) Inventors: Mark Allen Hartman, Inyokern, CA (US); Charles Fredric Hartman, Boron, CA (US)

(21) Appl. No.: 13/374,204

(22) Filed: Dec. 14, 2011

(51) Int. Cl. B05C 5/00

(52) U.S. Cl. 118/300

(57) ABSTRACT

One embodiment of a hand held elongated material cylinder (4), capped on one end having a pistol gripped trigger assembly (8), for the introduction of compressed air against free floating piston (6), utilized for the propulsion of wet-mix cementitous materials, loaded in the opposing side of the cylinder (4), enclosed with a nozzle cap (10), introducing compressed air around its tapered circumference, used for expelling the propelled material through a flexible nozzle tip (12) with a reduced aperture, at velocity to a described substrate needing repair or coating.

### BACKGROUND

### Prior Art

The repair of damaged or deteriorating concrete on previously constructed structures, bridges, reservoirs, and dams is an ongoing maintenance issue. The repairs generally consist of the removal of unsound portions of the concrete, surface preparation and cleaning followed by replacement of the damaged material with new cementitious materials to the lines and grades of the original surface profile. Historically, these repairs have been done using several methods depending on the size and scope of the repairs, and the economic feasibility of the repair method selected. Most repairs are generally not total surface replacements and the complete structure is not replaced. The damaged areas are typically repaired using either the dry method or the wet-mix method. The dry or Gunite method usually consists of the cement and sand/aggregate being mixed together dry and propelled through a material hose with air to the work area where water is added to the mixture. This addition of water, called hydration, mixes the dry material and water in the front of the nozzle before it is expelled out the nozzle tip at velocity where it impacts the desired surface to be repaired. The force of the material impacting the surface consolidates the material and helps achieve adhesion to the surface.

Studies over the years have concluded that the quantity of water mixed with the cement, or water-cement ratio, are directly related to the quality and strength of the mixture. Engineers and chemist have devised water-cement ratios that give a fair prediction of the quality and strength characteristics of a given mix. The disadvantage of the dry method is that the water cement ratio is variable and virtually immeasurable due to the nozzle-man controlling the addition of water at the nozzle with a hand valve.

In the wet-mix method, the quantity of both materials and water is measured and mixed, giving a controllable specific water-cement ratio.

In the repair field, manufacturers have come up with pre-mixed bag products with chemical enhancements that offer high performance characteristics. These products usually specify exact quantities of water, with test data and reliable performance histories.

For some repairs, the quantities are not very large.

Wet-mix application refers to the method in which dry cementitious material, consisting of a mixture of cement, fine and/or coarse aggregate, occasionally chemical enhancements, is first mixed with a liquid, usually water, and then conveyed, typically with a pump, through a hose, to an outlet at the desired location of work.

The repair of damaged vertical and overhead concrete surfaces is typically done with one or all, of the following three wet-mix methods; formed and poured, shotcrete, hand application. The disadvantages of these current application methods will become apparent with further explanation. Formed and poured repairs are usually performed when the area of the repair is rather large and/or deep, when access is easy for the installation of form work and the introduction of the repair materials, where gravity is conducive to the adhesion of the material to the substrate and the area to be filled. Conveyance of the material is typically by pump, through a material hose to the work area. This method is usually not used for overhead repairs that are small or shallow, or in situations where the repairs are scattered over a large area and the repairs are small.

Shotcrete refers to the method where the material is typically pumped through a hose, to a shotcrete nozzle that utilizes compressed air to propel the material at velocity against the substrate of the repair area. Shotcrete repairs are generally performed under the same conditions as formed and poured repairs, but require little or no form work. The consolidation and adhesion of the material is accomplished by the act of the material impacting the substrate at velocity.

The disadvantages of this method are the same as formed and poured with regards to the size and location of the repairs to be performed.

Hand application is utilized when the areas to be repaired are small and/or shallow, each repair is spread over a large area, or the particular material hardens to quickly to use either of the other methods mentioned. The disadvantages to this method is the rather slow and tedious rate of application, the amount of labor needed, and the act of applying by hand tends to cause the water within the material to migrate to the outer perimeter of the repair mortar, causing it to either sag or fail to adhere to the substrate.

There are a variety of small pumps available for the application of repair mortars, which include ball pumps, screw feed or roto-stator pumps, and swing tube pumps. Each has its inherent deficiencies in the type of materials and viscosities they can pump, and they generally all need to pump through hoses to the work area, using more material than needed for the repair, and require a specified time frame for the allowance of mixing, placing, and finishing before the material begins to harden.

### SUMMARY

In accordance with one embodiment, a hand-held self contained pneumatic repair mortar gun capable of placing small quantities of repair mortar utilizing the shotcrete method.

### Advantages

Accordingly, several advantages of one or more aspects are as follows:
(a) To provide a means for the placement of small quantities of repair mortar on vertical and overhead surfaces using the shotcrete method without the need of motorized pumping equipment, material hose, and large quantities of material to achieve the end result.
(b) Providing a means in which material, including material unusable in this fashion prior, with a short duration of usability between mixing and hardening, known as pot life, can be utilized with the shotcrete method, eliminating the need for hand application.
(c) Providing an economical means in which to utilize the pneumatic placement method without the high investment or cost associated with the use of the prior art equipment.
(d) Providing a means of equipment that at minimum allows placement of small quantities of material, and at maximum provides an alternative economical method for applications of larger quantities usually reserved for prior art equipment.

### DRAWINGS—FIGURES

FIG. 1 is an overall side view of the embodiments with a cut through showing interior free floating piston.

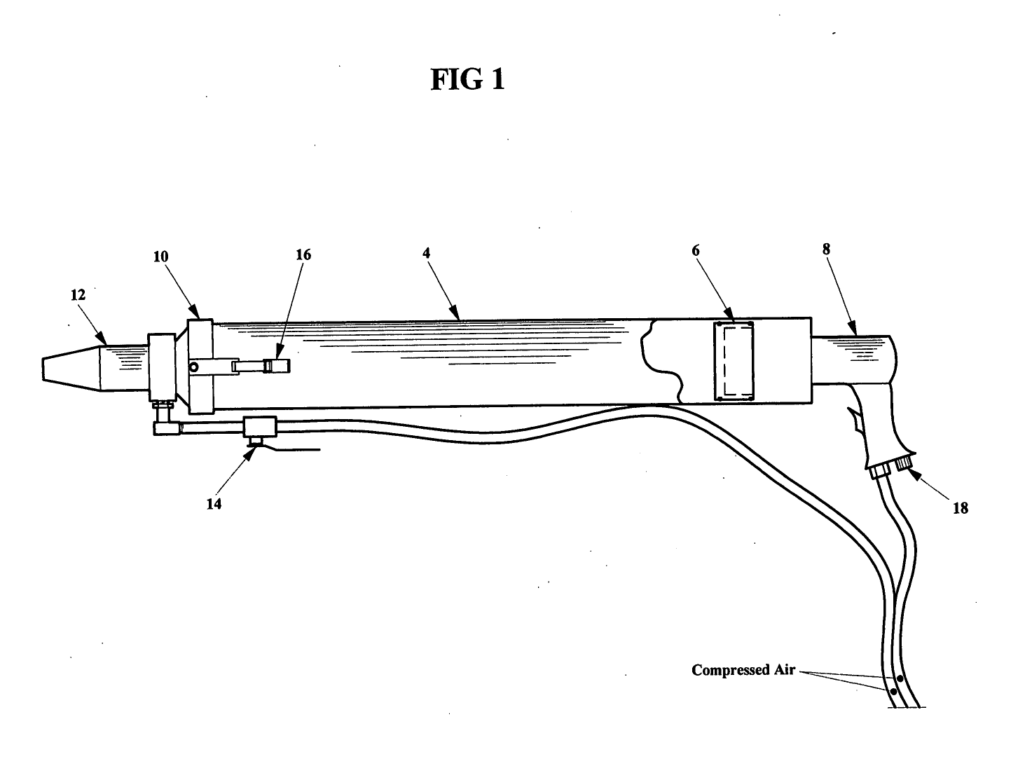

FIG. 2 is a cross section of the free floating piston.

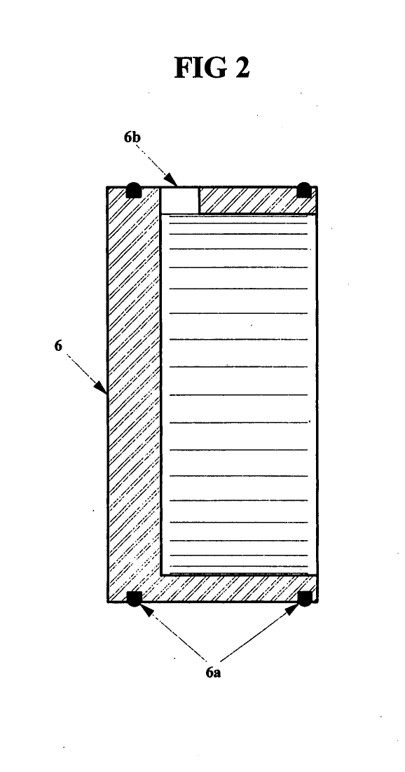

FIG. 3 is a cross section of the nozzle cap and flexible nozzle tip.

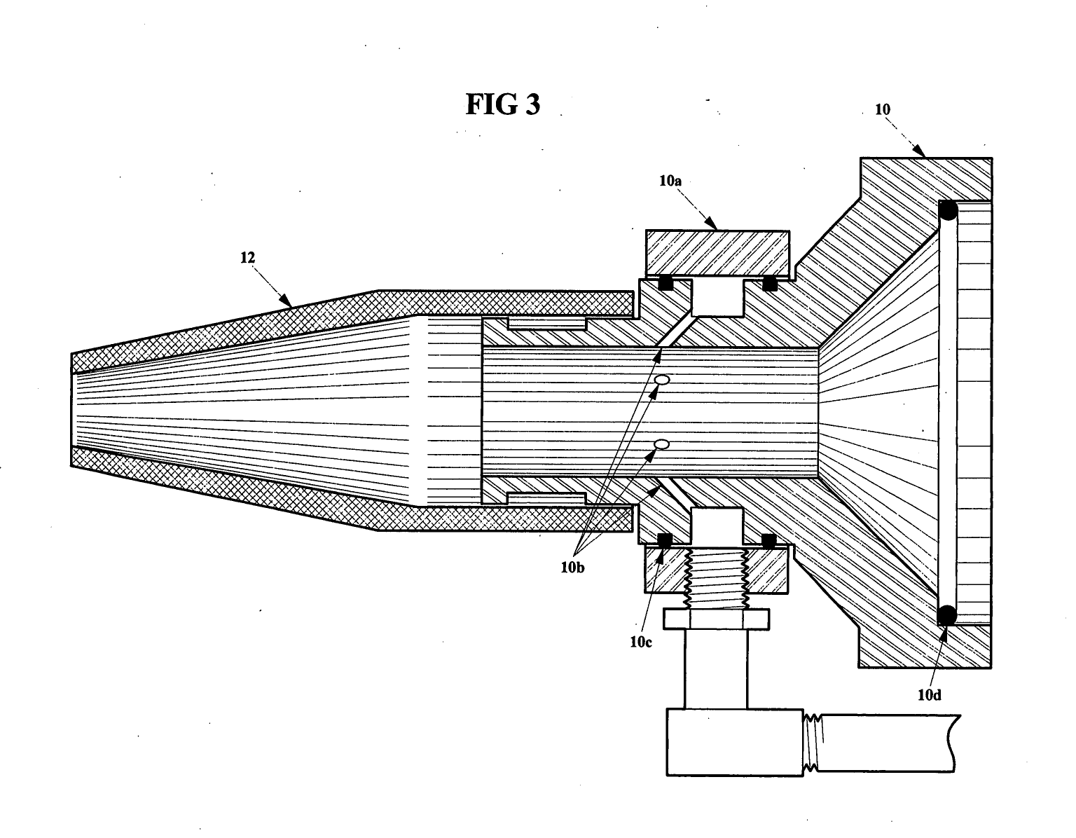

A cross section of the pistol grip trigger assembly is not shown, as this is a standard over the counter air-chisel body modified for this use.

### DESCRIPTION

The embodiment is a light weight, hand-held material cylinder (4) with a free floating piston (6) inside that is activated by compressed air supplied by an outside air compressor. The compressed air is introduced into the cylinder (4) against the backside of the piston (6) by way of the pistol gripped trigger assembly (8), which pushes the wet-mixed material on the out let side of the cylinder (4) into the nozzle cap (10), whereby compressed air is introduced through holes (10a) around the circumference of the nozzle cap (10). This propels the wet-mix material through a flexible nozzle tip (12) with a reduced aperture at the end and expels the material at velocity toward the desired substrate. Once all of the material has been expelled, the trigger (8) is released, the flexible nozzle tip (12) is bent over by hand, blocking the outlet passageway, and the ball valve (14) attached to the nozzle cap (10) is turned to the “on” position, pushing the piston (6) to the back of the cylinder (4). The ball valve (14) is then turned to the “off” position, the nozzle cap (10) is removed by releasing the two over-center snap clamps (16) attached to the cylinder (4) and the nozzle cap (10), allowing the cylinder (4) to be loaded with wet-mixed material.

The speed of the piston (6) pushing the material is controlled by a regulator screw (18) on the bottom side of the pistol-gripped trigger assembly (8).

The piston (6) maintains its seal with O-rings (6a).

When the nozzle cap (10) is removed, the piston (6) is kept from accidently blowing out of the cylinder (4) at velocity by a relief hole (6b) that relieves the air pressure behind the piston (6) once that portion of the piston (6) passes the edge of the cylinder (4).

The nozzle cap (10) air ring (10a) is sealed using two O-rings (10c). The nozzle cap (10) is sealed at the cylinder (4) using an O-ring (10d).

### Operation

The manner of using the pneumatic repair mortar gun is with the nozzle cap (10) off and the piston (6) against the back of the cylinder (4). Load the cylinder (4) full of the desired wet-mixed repair mortar, concrete, grout, etc.

Once the cylinder (4) is full, place the nozzle cap (10) over the opening on the cylinder (4), and secure the nozzle cap (10) with the over-center snap clamps (16).

Point the pneumatic repair mortar gun at the desired surface to receive the repair and adjust the nozzle cap (10) air to the desired volume using the ball Valve (14) attached to the nozzle cap (10). Hold the gun approximately 12 to 18 inches from the area to receive the repair at a right angle to the substrate and pull the trigger on the pistol gripped trigger assembly (8). Spray the repair materials to the desired thickness releasing the trigger when no material is desired. Once the cylinder (4) is empty, follow the directions for re-filling the cylinder (4) as described above.

### Advantages

From the description above, a number of advantages of some embodiments of my pneumatic repair mortar gun become evident:
(a) With an unlimited supply of air hose, the user will be able to install repairs of various sizes and quantities regardless of pot life restrictions of the materials and distance from the compressor or outside access.
(b) Since the material is utilized directly from the material cylinder to the nozzle cap, there is not any hose friction or loss of water due to friction.
(c) Only the quantity of material desired or needed be mixed at any one time, allowing complete quality control over installation and finishing of repairs, within the time frame dictated by the materials properties.
(d) Simple, lightweight design, allowing for fewer malfunctions, and simple operation.
(e) Economical advantage due to obvious simple fabrication, allowing for one or multiple guns to be utilized on a project, using only one 165 CFM air compressor.

### CONCLUSION, RAMIFICATIONS, AND SCOPE

Accordingly, the reader will see that the above described embodiments will allow for the repair of vertical and overhead concrete surfaces in an efficient manner utilizing the shotcrete method of pneumatic placement in areas and with materials of various small quantities that were considered uneconomical in the past or incapable of being achieved with the pneumatic method. The quality of small repairs normally relegated to hand applied will be greatly increased due to the feasibility of utilizing the shotcrete method on such small repairs.

Although the description above contains many specificities, these should not be limiting the scope of the embodiments but as merely providing illustrations of several embodiments. For example, the nozzle cap can have other shapes and uses on the outlet side, other materials may be introduced through the basic configuration.

I claim:

1. A hand held machine for the pneumatic application of cementitious materials in small quantities comprising;
a. an elongated pneumatic cylinder with a free floating piston inside capped on one end with an inlet,
b. attached at said inlet a pistol gripped trigger assembly utilized to introduce compressed air behind said piston when trigger is depressed and having cementitious material loaded on opposing side of said piston, material is propelled forward into a nozzle cap,
c. said nozzle cap on the opposing end of said cylinder tapering down to a predetermined diameter, where material propelled forward enters said nozzle cap, which contains air inlet holes around the circumference thereof,
d. compressed air introduced at said inlet holes propels the material through a flexible nozzle tip with a reduced aperture, expelling the material at velocity.
